(19) United States
(12) Patent Application Publication
(10) Pub. No.: US 2020/0022324 A1
(43) Pub. Date: Jan. 23, 2020

(54) HYDROPONICS APPARATUS AND METHOD

(71) Applicant: Avocet IP Limited, Berwick Upon Tweed, Northumberland (GB)

(72) Inventor: James Robert JENNINGS, Yarm, North Yorkshire (GB)

(21) Appl. No.: 16/465,653

(22) PCT Filed: Dec. 4, 2017
(86) PCT No.: PCT/EP2017/025352

§ 371 Date: May 31, 2019

(30) Foreign Application Priority Data
Dec. 2, 2016 (GB) 1620557.7

(51) Int. Cl. A01G 31/06; A01G 7/04

(52) U.S. Cl. CPC A01G 31/06; A01G 2031/006; A01G 7/045

(57) ABSTRACT

A hydroponics apparatus for growing feed for livestock includes a plurality of elongate trays for receiving seeds, an environmental control arrangement for controlling in operation a temperature and humidity of the plurality of elongate trays, and a nutrient solution supply arrangement for providing a nutrient solution to the seeds on the plurality of trays, wherein
the environmental control arrangement maintains the nutrient solution and an environment of the plurality trays at a temperature in a range of 19° C. to 25° C.; and
the plurality of trays is provided in operation with a substantially similar flow rate of the nutrient solution.

### TECHNICAL FIELD

The present disclosure relates to apparatus for growing feed for livestock. In particular, the present disclosure relates to hydroponics apparatuses for growing feed for livestock and methods of operating aforementioned hydroponics apparatus.

### BACKGROUND

Present farming techniques for rearing cattle are not sufficiently productive to meet future demand for meat products at a cost that future population are likely to be able to afford, as energy-per-capita (e) falls drastically as a consequence of increasing World population (presently 7 billion people) and depletion of fossil fuel reserves (for example, Saudi Ghawar giant oil field only has 208 billion barrels of oil remaining, and the World presently uses circa 80 million barrels of oil per day to function). As a result, there arises a technical problem of how to make agriculture more efficient and productive, especially in respect of meat production, as energy-per-capita (e) falls.

Livestock is typically conventionally allowed to graze in pasture and similar terrain, and fed on silage in winter, wherein the silage is generated from harvested plant material, by way of a fermentation process. The silage provides the livestock with sufficient nutrition to survive, it is not particularly exciting for the livestock to eat, that enjoy fresh plant material with exciting aroma and texture; this is important with regards to animal welfare.

Although intensively farmed animals are known, for example as in poultry industry, such techniques are not suitable for other types of animals than poultry. Therefore, there arises a need to provide improved livestock feed production apparatus for supporting advanced highly productive forms of agriculture. Of particular importance is to ensure that cattle receive sufficient roughage for their digestive systems to function in an efficient manner, that is also conducive to good animal welfare.

### SUMMARY

The present disclosure seeks to provide a hydroponics apparatus for growing feed for livestock. Moreover, the present disclosure seeks to provide a method of using a hydroponics apparatus for growing feed for livestock.

According to a first aspect of the present disclosure, there is provided a hydroponics apparatus for growing feed for livestock, characterized in that the hydroponics apparatus includes a plurality of elongate trays for receiving seeds, an environmental control arrangement for controlling in operation a temperature and humidity of the plurality of elongate trays, and a nutrient solution supply arrangement for providing a nutrient solution to the seeds on the plurality of trays, wherein:
(i) the environmental control arrangement is operable to maintain the nutrient solution and an environment of the plurality trays at a temperature in a range of 19° C. to 25° C.; and
(ii) the plurality of trays is provided in operation with a substantially similar flow rate of the nutrient solution,
   characterized in that the hydroponics apparatus includes a gaseous ozone fumigation arrangement for fumigating the seeds temporally periodically on the plurality of trays in response to detection of mould formation for reducing an occurrence of mould growth on the seeds, and roots and shoots of the seeds resulting from germination and growing of the seeds, and the environmental control arrangement is operable to maintain the plurality of trays at a relative humidity in a range of 40% to 80%.

The present disclosure is of advantage in that hydroponics apparatus provide efficient plant growth by eliminating problems of mould growth. Embodiments of the present disclosure provide adequate humidity in various trays of the hydroponic apparatus required for efficient plant growth in a light excluded environment.

Optionally, the plurality of trays is disposed in operation so that the elongate axis of each tray is at a tilted angle in operation with respect to a horizontal plane, wherein the tilted angle is of a magnitude for allowing run-off of the nutrient solution and avoidance of ponding of the nutrient solution along the plurality of elongate trays.

Optionally, the gaseous ozone fumigation arrangement is operable to:
expose the plurality of trays to a concentration of ozone in a range of 10 p.p.m.v. to 50 p.p.m.v. for a period in a range of 1 minute to 60 minutes, more optionally at an ozone concentration of substantially 30 p.p.m.v. for 30 minutes; and
maintain the plurality of trays at a temperature above 22° C.

Optionally, the hydroponics apparatus is operable to create a light-excluded environment for the seeds to germinate to develop roots and shoots. More optionally, the hydroponics apparatus includes a controllable lighting arrangement for selectively illuminating sub-portions of the seeds on the trays for providing differentiated growth of the seeds along the plurality of trays.

Optionally, the plurality of trays is mounted upon a moveable carousel for allowing for automated loading of seeds onto the plurality of trays and automated off-loading of their germinated seeds, and their roots and shoots, onto a carrier for removal from the apparatus for feeding to livestock.

Optionally, the fumigation arrangement is operable to provide gaseous fumigation of the seed prior to germination. More optionally, the gaseous ozone fumigation arrangement is operable to provide gaseous fumigation of the seed during growing of the seed in a substantially light-excluded environment.

Optionally, the plurality of trays has a length-to-width ratio in a range of 3:1 to 10:1.

Optionally, the plurality of trays is provided with an actuation arrangement for selectively flexing regions of the trays for sweeping ponding of nutrient solution occurring therein along a length of the trays.

Optionally, the trays are arranged in one or more vertical stacks, wherein planes of the trays for receiving the grain are substantially mutually parallel.

According to a second aspect, there is provided a method for growing feed for livestock using a hydroponics apparatus pursuant to the first aspect, characterized in that the hydroponics apparatus includes a plurality of elongate trays for receiving seeds, an environmental control arrangement for controlling in operation a temperature and humidity of the plurality of elongate trays, and a nutrient solution supply arrangement for providing a nutrient solution to the seeds on the plurality of trays, wherein the method includes:
(i) operating the environmental control arrangement to maintain the nutrient solution and an environment of the plurality trays at a temperature in a range of 19° C. to 25° C.; and
(ii) arranging for the plurality of trays to be provided in operation with a substantially similar flow rate of the nutrient solution,
   characterized in that the method includes arranging for the hydroponics apparatus to include a gaseous ozone fumigation arrangement for fumigating the seeds temporally periodically on the plurality of trays in response to detection of mould formation for reducing an occurrence of mould growth on the seeds, and roots and shoot of the seeds resulting from germination and growing of the seeds, and the method includes arranging for the environmental control arrangement to be operable to maintain the plurality of trays at a relative humidity in a range of 40% to 80%.

Optionally, the method includes arranging for the plurality of trays to be disposed in operation so that the elongate axis of each tray is at a tilted angle in operation with respect to a horizontal plane, wherein the tilted angle is of a magnitude for allowing run-off of the nutrient solution and avoidance of ponding of the nutrient solution along the plurality of elongate trays.

Optionally, the method includes arranging for the gaseous ozone fumigation arrangement to be operable to expose the plurality of trays to a concentration of ozone in a range of 10 p.p.m.v. to 50 p.p.m.v. for a period in a range of 1 minute to 60 minutes, more optionally at an ozone concentration of substantially 30 p.p.m.v. for 30 minutes and maintain the plurality of trays at a temperature above 22° C.

Optionally, that the method includes arranging for the hydroponics apparatus to be operable to create a light-excluded environment for the seeds to germinate to develop roots and shoots.

Optionally, the method includes arranging for the hydroponics apparatus to include a controllable lighting arrangement for selectively illuminating sub-portions of the seeds on the trays for providing differentiated growth of the seeds along the plurality of trays.

Optionally, the method includes arranging for the plurality of trays to be mounted upon a moveable carousel for allowing for automated loading of seeds onto the plurality of trays and automated off-loading of their germinated seeds, and their roots and shoots, onto a carrier for removal from the apparatus for feeding to livestock.

Optionally, the method includes arranging for the fumigation arrangement to be operable to provide gaseous fumigation of the seed prior to germination.

Optionally, the method includes arranging for the gaseous ozone fumigation arrangement to be operable to provide gaseous fumigation of the seed during growing of the seed in a substantially light-excluded environment.

Optionally, the method includes arranging for the plurality of trays to have a length-to-width ratio in a range of 3:1 to 10:1.

Optionally, the method includes arranging for the plurality of trays to be provided with an actuation arrangement for selectively flexing regions of the trays for sweeping ponding of nutrient solution occurring therein along a length of the trays.

Optionally, the method includes arranging for the trays to be disposed in one or more vertical stacks, wherein planes of the trays for receiving the grain are substantially mutually parallel.

It will be appreciated that features of the disclosure are susceptible to being combined in various combinations without departing from the scope as defined by the appended claims.

### DESCRIPTION OF THE DIAGRAMS

Embodiments of the present disclosure will now be described, by way of example only, with reference to the following diagrams wherein:

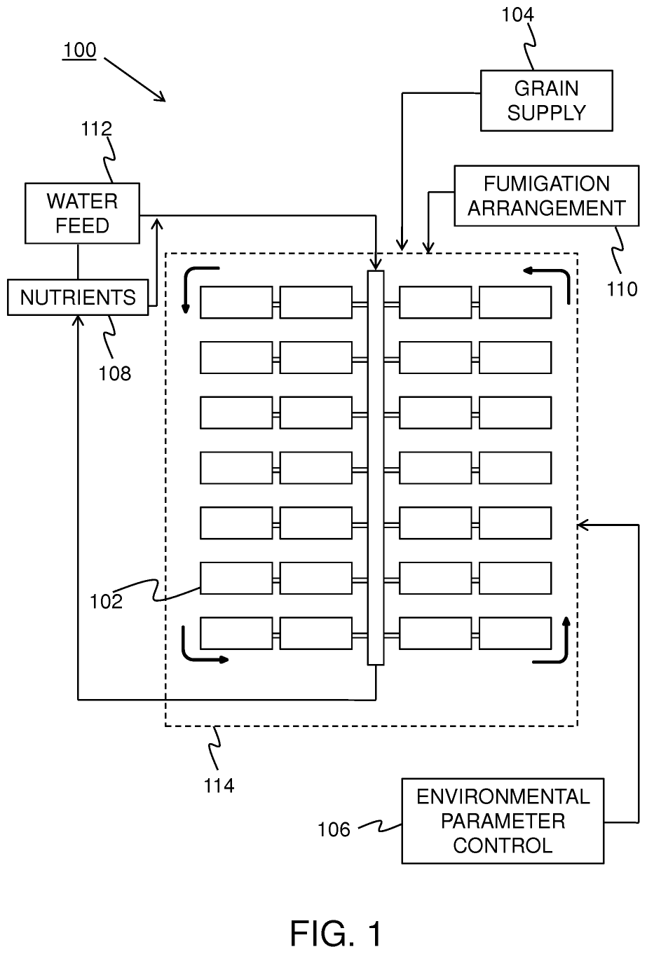

FIG. 1 is a block diagram of a hydroponics apparatus for growing feed for livestock, in accordance with an embodiment of the present disclosure;

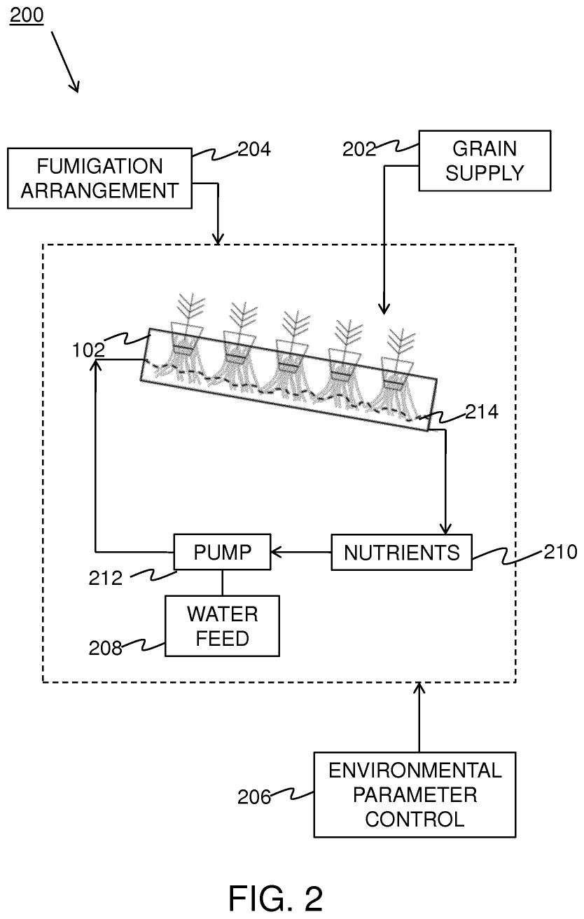

FIG. 2 is an illustration of an elongated tray of the hydroponics apparatus of FIG. 1, in accordance with an embodiment of the present disclosure; and

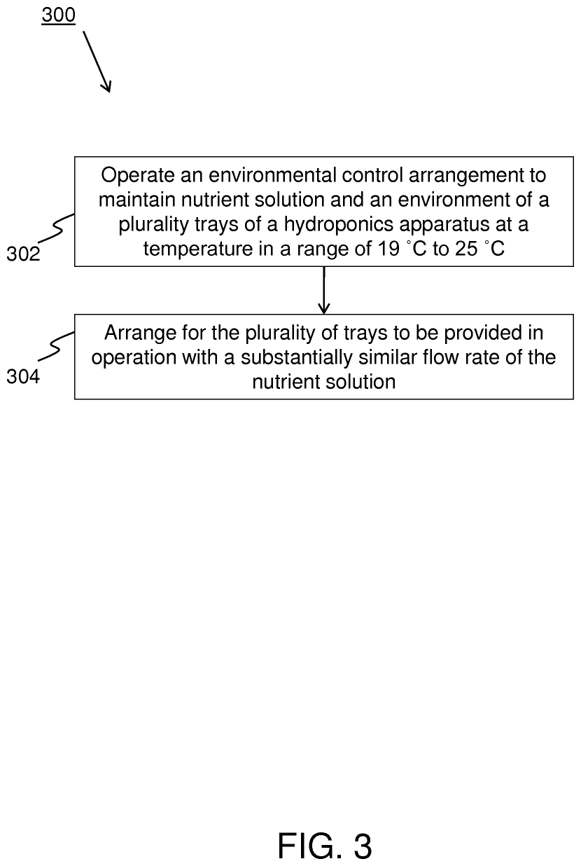

FIG. 3 is an illustration of steps of a method for growing feed for livestock using a hydroponics apparatus, in accordance with an embodiment of the present disclosure.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

FIG. 1 is a block diagram of a hydroponics apparatus 100 for growing feed for livestock, in accordance with various embodiments of the present disclosure. As shown, FIG. 1 illustrates various functional components of the hydroponics apparatus 100 growing feed for livestock. The hydroponics apparatus 100 includes a plurality of elongated trays 102 for receiving seeds from a grain supply arrangement 104. The hydroponics apparatus 100 also includes an environmental parameter control arrangement 106 operable to control a temperature and humidity of the plurality of elongate trays 100 while growing the feed for livestock. Moreover, the hydroponics apparatus 100 also includes a nutrient solution supply arrangement 108 for providing a nutrient solution to the seeds on the plurality of trays 102.

The hydroponics apparatus 100 further includes a fumigation arrangement 110 for removing moulds from the seeds supplied from the grain supply arrangement 104 and a water feed arrangement 112 for supplying clean water to the elongated trays 102. Further, the elongated trays 102 may be arranged on a carousel.

The environmental parameter control arrangement 106 of the hydroponics apparatus 100 is operable to maintain the nutrient solution and the plurality of elongated trays 102 at a temperature in the range of 19° C. to 25° C., and the plurality of elongated trays 102 may be provided in operation with a substantially similar flow rate of the nutrient solution.

In an embodiment, the environmental parameter control arrangement 106 of the hydroponics apparatus 100 may be operable to maintain the plurality of trays 102 at the temperature above 22° C.

In another embodiment, the environmental parameter control arrangement 106 of the hydroponics apparatus 100 may be operable to maintain the temperature of water based feed supplies from the water feed arrangement 112.

In an embodiment, the environmental parameter control arrangement 106 of the hydroponics apparatus 100 may be operable to maintain the plurality of trays 102 at a relative humidity in a range of 40% to 80%.

The nutrient solution supply arrangement 108 may be operable to provide the nutrient solution to the seeds on the plurality of trays 102. Optionally, the nutrient solution supply arrangement 108 may be connected to the water feed arrangement 112 resulting to form a water based feed for the seed in the hydroponics apparatus.

In an embodiment, the hydroponics apparatus 100 may be operable to create a substantially light-excluded environment for the seeds in the trays 102 to germinate to develop roots and shoots. In present embodiment, the hydroponics apparatus 100 may include a controllable lighting arrangement for selectively illuminating sub-portions of the seeds on the trays 102 for providing differentiated growth of the seeds along the plurality of trays 102. For example, the controllable lighting arrangement may include energy efficient LED's of various colours.

In an embodiment, the plurality of trays 102 of the hydroponics apparatus 100 may be disposed in operation so that elongate axis of each elongated tray 102 may be tilted at an angle in operation with respect to a horizontal plane, wherein the tilted angle is of a magnitude for allowing run-off of the nutrient solution and avoidance of ponding of the nutrient solution along the plurality of elongate trays.

In an exemplary embodiment, the trays 102 may be tilted at an angle ratio 1:100 to obtain water runoff from the water feed arrangement 112. Optionally, in different embodiments of the present disclosure the trays 102 may be tilted in a range of the angle ratio 1:50 to 1:20 for avoiding ponding.

In an embodiment, the plurality of trays 102 may be mounted upon a moveable carousel 114 for allowing automated loading of the seeds onto the plurality of trays 102 and automated off-loading of their germinated seeds, and their roots and shoots, onto a carrier for removal from the hydroponics apparatus 100 for feeding to livestock.

In another embodiment, the plurality of trays 102 may be provided with an actuation arrangement for selectively flexing regions of the trays 102 for sweeping ponding of nutrient solution occurring therein along a length of the trays 102. For example, actuation arrangement may be activated in a sequence along a length of the trays to sweep any ponding along the trays. The actuators may be electromagnetic actuators that are actuated under computer control, although hydraulic actuators can alternatively be employed.

In an embodiment, the trays 102 may be arranged in one or more vertical stacks. In present embodiment, planes of the trays 102 for receiving the seeds from the grain supply arrangement 104 are substantially mutually parallel.

In another embodiment, trays 102 may be mounted on a vertically rotating carousel and may be pivotable along one of their elongate edges to enable rapid automated emptying of the trays 102 into a collection holder, wherein the germinated grain may be pulverized as aforementioned to provide livestock feed. In the present embodiment, the pulverization may only be partial so as to provide the livestock with interesting texture to munch (for example, to provide for roughage for their digestive system).

In an embodiment, the fumigation arrangement 110 of the hydroponics apparatus 100 is operable to remove moulds on the supplied seeds by gaseous fumigation during germination of the seeds in light excluded environment. In present embodiment, the fumigation arrangement 110 may use ozone gas for fumigating the supplied grain to reduce growth of mould in the plant growth material. The ozone gas may be used temporally periodically in combination with sulphur dioxide and/or chlorine gas for fumigating the supplied grain in response to detection of mould formation upon the supplied grain, its roots and/or shoots.

In another embodiment, the fumigation arrangement 110 of the hydroponics apparatus 100 is operable to remove moulds from the roots and the shoots of the resulting from germination of seeds in the trays 102.

In an embodiment, formation of Aspergillus on the supplied grains may be reduced by fumigating the trays 102 by ozone gas. For example, the trays 102 may be exposed to the ozone gas in periodic intervals. The ozone gas concentration may be in range of 10 p.p.m.v. to 50 p.p.m.v.. The ozone exposure may be implemented for a duration of 1 minutes to 60 minutes (1 hour). The ozone is beneficially generated from a discharge process, for example from a corona discharge process or similar. The ozone is preferably directed to roots of the germinated grain in the trays, where possible. The grain is spread evenly around the trays to avoid bunching of distribution of the grain that could cause potential occurrence of Aspergillus or similar mould growth. For example, ozone concentration of 30 p.p.m. may be applied for 30 minutes in the hydroponics apparatus 100.

Optionally in an embodiment, other gases are employed in combination with ozone, for example Sulphur Dioxide, Nitrous Oxides, to hinder mould growth, with periodic application as aforementioned. Alternatively, the gaseous treatment for Aspergillus is supplied continuously. Alternatively, the gaseous treatment for Aspergillus is selectively applied only when a trace of Aspergillus is first detected. The trays are beneficially treated with ozone and/or bleach to kill any residual Aspergillus or similar mould between growth cycles of the grain therein.

Additionally, in an embodiment, the fumigation arrangement 110 may be connected to the environmental parameter control arrangement 106 and operable to release ozone periodically for formation of Aspergillus on the supplied grains on the trays 102.

FIG. 2 is a block diagram of an elongated tray 102 of the hydroponics apparatus 100, in accordance with an embodiment of the present disclosure. As shown, the elongated tray 102 includes seeds received from a grain supplied unit 202 (such as the grain supply unit 104 of FIG. 1). The tray 102 is connected to a fumigation arrangement 204 (such as the fumigation arrangement 110) for fumigating the seeds, roots and/or shoots of the seed during germination. The tray 102 is also connected to an environmental parameter control arrangement 206 (such as the environmental parameter control arrangement 106 of FIG. 1) for maintaining environmental conditions (for example, temperature and humidity) of the trays 102. The tray 102 is further connected to a water feed 208 (such as the water feed arrangement 112 of FIG. 1) and a nutrient supply arrangement 210 (such as the nutrient supply arrangement 108 of FIG. 1) via a pump 212 operable to create a water based feed 214 in the tray 102.

In an embodiment, the nutritional requirement of the seeds during germination and growth may be fulfilled by NFT (nutrient feed technique) system.

In an embodiment, the trays 102 may be elongated in a length-to-width ratio in a range of 3:1 to 10:1. For example, the germination and growth trays 102 may be 30 cm to 1 meter wide. More specifically, the germination and growth trays 102 may be 60 cm to 80 cm wide. The trays 102 are optionally fabricated from a plastics material. A temperature of the trays 102 may occur in a range of 17° C. to 23° C., more optionally in a range of 20° C. to 22° C.

FIG. 3 is an illustration of steps of a method 300 for growing feed for livestock using a hydroponics apparatus (such as hydroponics apparatus 100 of FIG. 1), in accordance with an embodiment of the present disclosure. At step 302, an environmental control arrangement (of the hydroponics apparatus) is operated to maintain nutrient solution, and an environment of a plurality trays (of the hydroponics apparatus) is operated at a temperature in a range of 19° C. to 25° C. At step 304, the plurality of trays is arranged to be provided in operation with a substantially similar flow rate of the nutrient solution.

The steps 302 to 304 are only illustrative and other alternatives can also be provided where one or more steps are added, one or more steps are removed, or one or more steps are provided in a different sequence without departing from the scope of the claims herein. For example, the method 300 may include arranging for the plurality of trays to be disposed in operation so that the elongate axis of each tray is at a tilted angle in operation with respect to a horizontal plane, wherein the tilted angle is of a magnitude for allowing run-off of the nutrient solution and avoidance of ponding of the nutrient solution along the plurality of elongate trays. Further, the method 300 may comprise arranging for the hydroponics apparatus to include a gaseous ozone fumigation arrangement for fumigating the seeds on the plurality of trays for reducing an occurrence of mould growth on the seeds, and roots and shoots of the seeds resulting from germination and growing of the seeds. Further, the method 300 comprises arranging for the gaseous ozone fumigation arrangement to be operable to expose the plurality of trays to a concentration of ozone in a range of 10 p.p.m.v. to 50 p.p.m.v. for a period in a range of 1 minute to 60 minutes, more optionally at an ozone concentration of substantially 30 p.p.m.v. for 30 minutes.

Further, the method 300 comprises arranging for the environmental control arrangement to be operable to maintain the plurality of trays at a temperature above 22° C. Furthermore, the method 300 comprises arranging for the environmental control arrangement to be operable to maintain the plurality of trays at a relative humidity in a range of 40% to 80%. Moreover, the method 300 comprises arranging for the hydroponics apparatus to be operable to create a substantially light-excluded environment for the seeds to germinate to develop roots and shoots. In particular, the relative humidity in the range of 40% to 80% is advantageous in terms of providing continuous uniform growth to shoots of the germinated seeds.

The method 300 comprises arranging for the hydroponics apparatus to include a controllable lighting arrangement for selectively illuminating sub-portions of the seeds on the trays for providing differentiated growth of the seeds along the plurality of trays. Further, the method 300 comprises arranging for the plurality of trays to be mounted upon a moveable carousel for allowing for automated loading of seeds onto the plurality of trays and automated off-loading of their germinated seeds, and their roots and shoots, onto a carrier for removal from the apparatus for feeding to livestock. Furthermore, the method 300 comprises arranging for the fumigation arrangement to be operable to provide gaseous fumigation of the seed prior to germination. Moreover, the method 300 comprises arranging for the fumigation arrangement to be operable to provide gaseous fumigation of the seed during growing of the seed in a substantially light-excluded environment.

Further, the method 300 comprises arranging for the fumigation arrangement to be operable to provide ozone gas fumigation temporally periodically for fumigating the seed in response to detection of mould formation upon the seed, its roots and/or shoots. Furthermore, the method 300 comprises arranging for the plurality of trays to have a length-to-width ratio in a range of 3:1 to 10:1. Moreover, the method 300 comprises arranging for the plurality of trays to be provided with an actuation arrangement for selectively flexing regions of the trays for sweeping ponding of nutrient solution occurring therein along a length of the trays. Optionally, the method 300 comprises arranging for the trays to be disposed in one or more vertical stacks, wherein planes of the trays for receiving the grain are substantially mutually parallel.

The apparatus and method for growing feed for livestock provided in the present disclosure may be configured to maintaining optimum level of CO₂ required for photosynthesis of the germinated seeds or fodder. For example, a gas feed arrangement may include one or more sensors for measuring the levels of CO₂ and/or for controlling the release of CO₂, maintaining it a required level or an optimum level of CO₂. The level of CO₂ may be controlled by a gas feed arrangement, or by adjusting one or more parameters of the fodder growth process, for example changes in temperature of operation which would with speed or slow chemical (or bio-chemical) reactions, including the fodder growth rate.

The present disclosure is advantageous in terms that hydroponics apparatus provides efficient plant growth by eliminating problems of mould growth. Further, the present disclosure is advantageous in a way that it is capable of providing a very low farming ground-to-production ratio, as the hydroponics apparatus is disposed in a vertically configuration, whilst allowing for accurately controlled concentrations of nutrients.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1-28. (canceled)

29. A hydroponics apparatus for growing feed for livestock, wherein the hydroponics apparatus includes a plurality of elongate trays for receiving seeds, an environmental control arrangement for controlling in operation a temperature and humidity of the plurality of elongate trays, and a nutrient solution supply arrangement for providing a nutrient solution to the seeds on the plurality of trays, wherein:
(i) the environmental control arrangement is operable to maintain the nutrient solution and an environment of the plurality trays at a temperature in a range of 19° C. to 25° C.; and
(ii) the plurality of trays is provided in operation with a substantially similar flow rate of the nutrient solution,
characterized in that the hydroponics apparatus includes a gaseous ozone fumigation arrangement for fumigating the seeds temporally periodically on the plurality of trays in response to detection of mould formation for reducing an occurrence of mould growth on the seeds, and roots and shoots of the seeds resulting from germination and growing of the seeds, and the environmental control arrangement is operable to maintain the plurality of trays at a relative humidity in a range of 40% to 80%.

30. The hydroponics apparatus of claim 29, wherein the plurality of trays is disposed in operation so that the elongate axis of each tray is at a tilted angle in operation with respect to a horizontal plane, wherein the tilted angle is of a magnitude for allowing run-off of the nutrient solution and avoidance of ponding of the nutrient solution along the plurality of elongate trays.

31. The hydroponics apparatus of claim 29, wherein the gaseous ozone fumigation arrangement is operable to:
expose the plurality of trays to a concentration of ozone in a range of 10 p.p.m.v. to 50 p.p.m.v. for a period in a range of 1 minute to 60 minutes, more optionally at an ozone concentration of substantially 30 p.p.m.v. for 30 minutes; and
maintain the plurality of trays at a temperature above 22° C.

32. The hydroponics apparatus of claim 29, wherein the hydroponics apparatus is configured to create a light-excluded environment for the seeds to germinate to develop roots and shoots, wherein the hydroponics apparatus includes a controllable lighting arrangement for selectively illuminating sub-portions of the seeds on the trays for providing differentiated growth of the seeds along the plurality of trays.

33. The hydroponics apparatus of claim 29, wherein the plurality of trays is mounted upon a moveable carousel for allowing for automated loading of seeds onto the plurality of trays and automated off-loading of their germinated seeds, and their roots and shoots, onto a carrier for removal from the apparatus for feeding to livestock.

34. The hydroponics apparatus of claim 29, wherein the fumigation arrangement is configured to provide gaseous fumigation of the seed prior to germination.

35. The hydroponics apparatus of claim 29, wherein the gaseous ozone fumigation arrangement is operable to provide gaseous fumigation of the seed during growing of the seed in a substantially light-excluded environment.

36. The hydroponics apparatus of claim 29, wherein the plurality of trays has a length-to-width ratio in a range of 3:1 to 10:1.

37. The hydroponics apparatus of claim 29, wherein the plurality of trays is provided with an actuation arrangement for selectively flexing regions of the trays for sweeping ponding of nutrient solution occurring therein along a length of the trays.

38. The livestock feed production apparatus of claim 29, wherein the trays are arranged in one or more vertical stacks, wherein planes of the trays for receiving the grain are substantially mutually parallel.

39. A method for growing feed for livestock using a hydroponics apparatus, wherein the hydroponics apparatus includes a plurality of elongate trays for receiving seeds, an environmental control arrangement for controlling in operation a temperature and humidity of the plurality of elongate trays, and a nutrient solution supply arrangement for providing a nutrient solution to the seeds on the plurality of trays, wherein the method includes:
(i) operating the environmental control arrangement to maintain the nutrient solution and an environment of the plurality trays at a temperature in a range of 19° C. to 25° C.; and
(ii) arranging for the plurality of trays to be provided in operation with a substantially similar flow rate of the nutrient solution,
wherein the method includes arranging for the hydroponics apparatus to include a gaseous ozone fumigation arrangement for fumigating the seeds temporally periodically on the plurality of trays in response to detection of mould formation for reducing an occurrence of mould growth on the seeds, and roots and shoot of the seeds resulting from germination and growing of the seeds, and the method includes arranging for the environmental control arrangement to be operable to maintain the plurality of trays at a relative humidity in a range of 40% to 80%.

40. The method of claim 39, wherein the method includes arranging for the plurality of trays to be disposed in operation so that the elongate axis of each tray is at a tilted angle in operation with respect to a horizontal plane, wherein the tilted angle is of a magnitude for allowing run-off of the nutrient solution and avoidance of ponding of the nutrient solution along the plurality of elongate trays.

41. The method of claim 39, wherein the method includes arranging for the gaseous ozone fumigation arrangement being configured to:
expose the plurality of trays to a concentration of ozone in a range of 10 p.p.m.v. to 50 p.p.m.v. for a period in a range of 1 minute to 60 minutes, more optionally at an ozone concentration of substantially 30 p.p.m.v. for 30 minutes; and
maintain the plurality of trays at a temperature above 22° C.

42. The method of claim 39, wherein the method includes arranging for the hydroponics apparatus to be operable to create a light-excluded environment for the seeds to germinate to develop roots and shoots, wherein the hydroponics apparatus to include arranging a controllable lighting arrangement for selectively illuminating sub-portions of the seeds on the trays for providing differentiated growth of the seeds along the plurality of trays.

43. The method of claim 39, wherein the method includes arranging for the plurality of trays to be mounted upon a moveable carousel for allowing for automated loading of seeds onto the plurality of trays and automated off-loading of their germinated seeds, and their roots and shoots, onto a carrier for removal from the apparatus for feeding to livestock.

44. The method of claim 39, wherein the method includes arranging for the fumigation arrangement to be operable to provide gaseous fumigation of the seed prior to germination.

45. The method of claim 39, wherein the method includes arranging for the gaseous ozone fumigation arrangement to be operable to provide gaseous fumigation of the seed during growing of the seed in a substantially light-excluded environment.

46. The method of claim 39, wherein the method includes arranging for the plurality of trays to have a length-to-width ratio in a range of 3:1 to 10:1.

47. The method of claim 39, wherein the method includes arranging for the plurality of trays to be provided with an actuation arrangement for selectively flexing regions of the trays for sweeping ponding of nutrient solution occurring therein along a length of the trays.

48. The method of claim 39, wherein the method includes arranging for the trays to be disposed in one or more vertical stacks, wherein planes of the trays for receiving the grain are substantially mutually parallel.
